(19) United States
(12) Patent Application Publication
(10) Pub. No.: US 2011/0029017 A1
(43) Pub. Date: Feb. 3, 2011

(54) TEETHING PACIFIER

(76) Inventor: JEREMY SHREVE, Big Piney, WY (US)

Correspondence Address: LAW OFFICE OF JERRY D. HAYNES , P.A, P.O. Box 350392, Fort Lauderdale, FL, 33335, US

(21) Appl. No.: 12/512,667

(22) Filed: Jul. 30, 2009

(51) Int. Cl. A61J 17/00

(52) U.S. Cl. 606/235; 29/428

(57) ABSTRACT

The present invention includes a teething pacifier for infants comprising: a nipple, where said nipple includes an inner chamber; a mouth shield, where said mouth shield supports the nipple and prevents accidental swallowing of the nipple; a handle; where said handle is attached to the outer side of the mouth shield; and a non-toxic liquid within the inner chamber, where the non-toxic liquid is capable of being frozen. In one exemplary embodiment, the non-toxic liquid may include either water, saline or distilled water. The present invention also includes a method of making a teething pacifier comprising the steps of: assembling a hollow nipple with an inner chamber onto to a mouth shield; attaching a handle to the outer side of the mouth shield; inserting a non-toxic liquid into the inner chamber of the nipple; and sealing the liquid in the inner chamber.

### BACKGROUND OF THE INVENTION

1. Field of Invention

The present invention relates to a teething pacifier to alleviate discomfort associated with infant teething.

2. Description of Related Art

Pacifiers are utilized to provide comfort and to possibly lull an infant to sleep by using a stimulating natural nipple. Pacifiers are usually comprised of a nipple portion, a mouth guard, and a small handle. The mouth guard or shell may be designed with a large enough circumference to avoid possible swallowing or choking of the pacifier by the infant. A pacifier usually includes a narrow and flexible area near the end of the nipple to allow for a natural biting motion for the infant. Many pacifiers are used merely to provide temporary comfort or to appease the infant.

An infant may become irritable during teething due to the discomfort in the introduction of teeth into a child's gums. Teething rings have been provided to help soothe some of the discomfort associated with the teething process. Most pacifiers are not provided with a means to address some of the discomfort associated with teething. A drawback associated with pacifiers involves the possibility that an infant may be become accustomed to the pacifier and may desire continued use of the pacifier during the teething process. Infants who may desire continued use of pacifiers might benefit from the use of a pacifier designed to use during teething.

### SUMMARY OF THE INVENTION

The present invention includes a teething pacifier for infants comprising: a nipple, where said nipple includes an inner chamber; a mouth shield, where said mouth shield supports the nipple and prevents accidental swallowing of the nipple; a handle; where said handle is attached to the outer side of the mouth shield; and a non-toxic liquid within the inner chamber, where the non-toxic liquid is capable of being frozen. In one exemplary embodiment, the non-toxic liquid may include either water, saline or distilled water.

The present invention also includes a method of making a teething pacifier comprising the steps of: assembling a hollow nipple with an inner chamber onto to a mouth shield; attaching a handle to the outer side of the mouth shield; inserting a non-toxic liquid into the inner chamber of the nipple; and sealing the liquid in the inner chamber. In one particular embodiment, the step of inserting includes using a syringe to pierce the nipple and insert the liquid into the inner chamber. The step of sealing may include the application of heat to the opening left by the syringe.

### BRIEF DESCRIPTION OF DRAWINGS

FIG. 1A depicts a bottom view of a teething pacifier according to the present invention.

FIG. 1B depicts a side view of a teething pacifier according to the present invention.

FIG. 1C depicts a top view of the teething pacifier according to the present invention.

### DETAILED DESCRIPTION

The present invention relates to a teething pacifier that has been conceived to alleviate discomfort associated with infant teething. The purpose of the teething pacifier according to the present invention is to assist in alleviating pain and swelling caused by the emergence of teeth through an infant's gums. The teething pacifier according to the present invention includes an inner chamber within the nipple that may be filled with a non-toxic liquid substance. This liquid substance may be frozen and then utilized by the infant to alleviate pain and discomfort associated with teething.

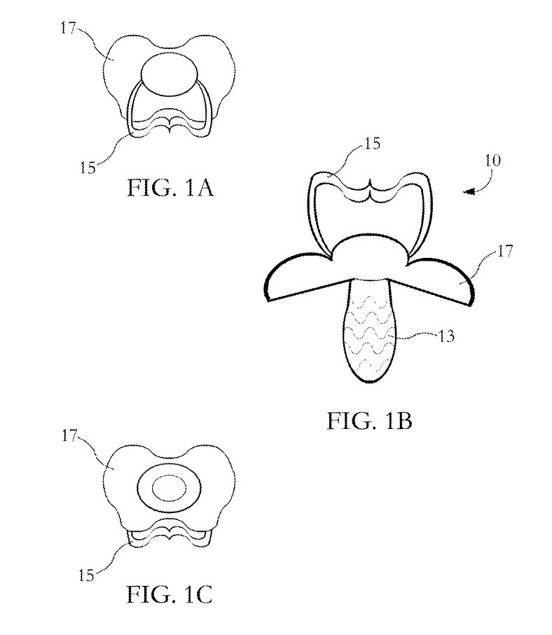

FIG. 1A depicts a bottom view of a teething pacifier 10 according to the present invention. The teething pacifier 10 includes a handle 15, a mouth guard 17 and a nipple 13, depicted in FIG. 1B. The mouth guard 17 extends beyond the circumference of the nipple 13 to provide a guard to prevent swallowing and choking on the nipple 13 during use. The handle 15 provides a means to manipulate the pacifier 10.

The nipple 13 includes an inner chamber that is filled with a non-toxic liquid substance. The non-toxic liquid substance may be water, saline or distilled water as desired by the user. A syringe needle is utilized to insert the liquid into the inner chamber of the nipple 13. A heat source is applied to the opening created by the syringe to seal the nipple so that the liquid substance does not leak during use. After the liquid substance has been inserted in the nipple 13, the teething pacifier 10 is ready for use by an infant.

The nipple 13 is made of a sufficient substance that may withstand freezing and the various temperatures associated with the use of the teething pacifier. Once the teething pacifier 10 has been placed into the freezer, the liquid substance is frozen so that an infant may utilize the pacifier. The teething pacifier 10 may therefore provide long lasting relief for an infant who may be teething. FIG. 1C depicts a top view of the teething pacifier 10. As noted the mouth guard 17 is of sufficient width and diameter as to prevent swallowing or choking on the teething pacifier 10.

Since the nipple 13 includes a sealed cavity that is filled with a liquid, the teething pacifier may be kept in the freezer over a period of time or removed and then frozen at the desired time for use. The design of the teething pacifier 10 provides comfort and helps to alleviate some of the side effects associated with teething that infants must suffer through.

What is claimed is:

1. A teething pacifier for infants comprising:
a. a nipple, where said nipple includes an inner chamber;
b. a mouth shield, where said mouth shield supports the nipple and prevents accidental swallowing of the nipple;
c. a handle; where said handle is attached to the outer side of the mouth shield; and
d. a non-toxic liquid within the inner chamber.

2. The teething pacifier according to claim 1, where the non-toxic liquid is at least one of water, saline and distilled water.

3. The teething pacifier according to claim 1, where the non-toxic liquid is capable of being frozen.

4. A method of making a teething pacifier comprising the steps of:
a. assembling a hollow nipple with an inner chamber onto to a mouth shield;
b. attaching a handle to the outer side of the mouth shield;
c. inserting a non-toxic liquid into the inner chamber of the nipple; and
d. sealing the liquid in the inner chamber.

5. The method according to claim 4, where said step of inserting includes using a syringe to pierce the nipple and insert the liquid into the inner chamber.

6. The method according to claim 5, where said step of sealing includes the application of heat to the opening left by the syringe.
